(19) United States
(12) Patent Application Publication
(10) Pub. No.: US 2009/0315211 A1
(43) Pub. Date: Dec. 24, 2009

(54) Hand and object casting method and kit

(76) Inventor: Robert Neil England, Yeovil (GB)

Correspondence Address: Mr. W. Eltzoth, 230E 4th Avenue, Ajo, AZ, 85321, US

(21) Appl. No.: 12/214,864

(22) Filed: Jun. 24, 2008

(51) Int. Cl. B29C 33/40

(52) U.S. Cl. 264/222

(57) ABSTRACT

A hand and object casting method and kit, introduction sheet FIG. 2, that includes the potential of leaving an object 2a inside the mould during a casting process. The product is a hard cast replica of the human hand 9a holding an original object 2a. The object at 2a is for illustration purposes only. Introduction sheet FIG. 2 to accompany abstract.

This invention relates to a hand and object casting method and kit.

Standard hand casting methods and casting kits use an impression taking material to create an initial mold of the form of the human hand. The hand is removed and a self hardening substance is applied to the empty mold to fill the void space of the shape and form left by the removed hand. When the substance has hardened the impression taking material is peeled away to expose the replica hand. The mold is destroyed in the process to retrieve the casting of the hand.

My Invention is an innovative development to the above casting method. My hand casting technique and the related casting kit details the new innovation. The human hand can hold most hand sized objects, for example a cricket ball, a piece of jewelery, a pencil or a small flower vase etc,. Any object that is capable of being held in the hand and immersed into the impression taking material, together with the hand.

The hand and a chosen object whilst being held is immersed into the material and when the material has set, only the hand is removed. The object remains immersed in the mold. The void left by the removed hand is then invested with a self hardening substance, that flows around the object and forms the shape of the vacant hand. When the substance has fully cured and has set rigid, both the replica hand casting and the original object are removed from the mold, revealing the replica hand holding the object.

The development of this unique idea allows for the opportunity to cast any human hand holding a favored object. The casting possibilities using this new method can incorporate any object capable of being held in the human hand.

### AN EXAMPLE OF THE INVENTION AS DESCRIBED BY THE ACCOMPANYING DRAWINGS

A standard Hand Casting Technique

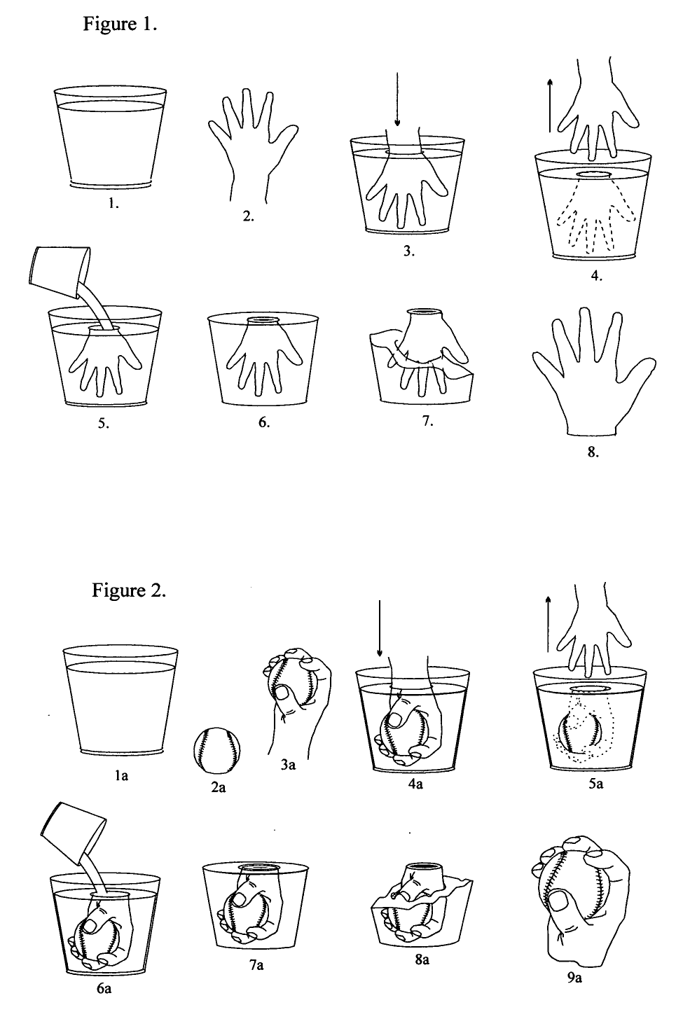

FIG. 1. Front View

Shows a standard hand casting technique and method. 1. A container of impression taking material. 2. The human hand to be cast. 3. The hand is immersed into the impression taking material until the material has set. 4. The hand is removed leaving a negative void space of the shape and form of the hand. 5. The hand mould is then invested with a self hardening substance. 6. The set hand-cast and moulding material are then removed from the casing. 7. The moulding material is then separated from the hand casting. 8. The replica hand as an ornament.

### A New Innovation to the Standard Hand Casting Technique.

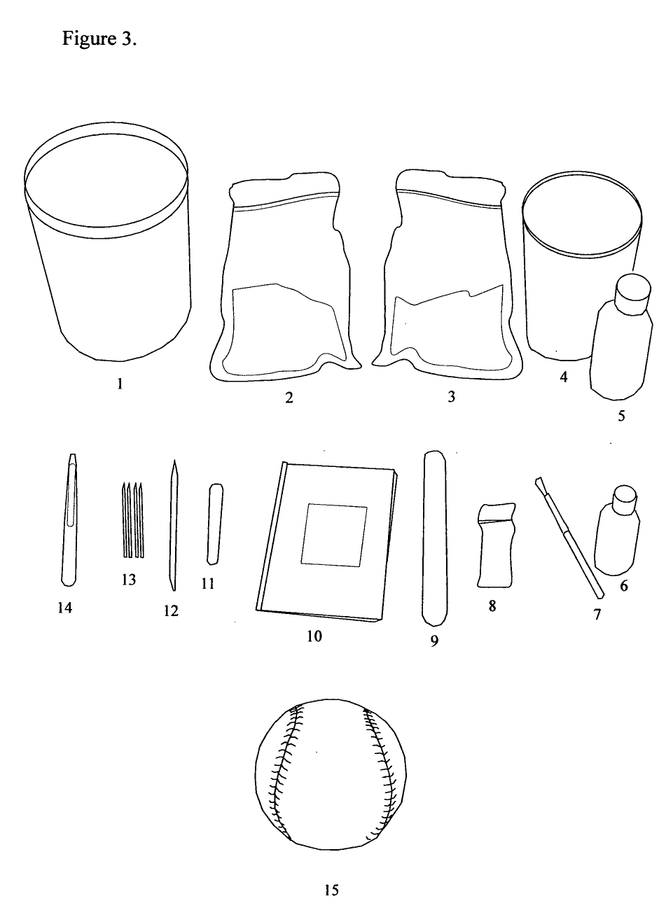

### FIG. 2. Side View.

Shows a new innovation to a standard hand casting technique and method. 1a. A container of impression taking material. 2a. A standard baseball. 3a. The human hand holding the baseball in pose. 4a. The hand holding the ball is immersed into the impression taking material until the material has set. 5a. The hand is removed leaving the ball inside the set material and surrounded by the negative void of the shape and form of the hand. 6a. The hand moulding containing the ball is then invested with a self hardening substance and remains until the substance has set. 7a. The set hand casting with the ball and the moulding material are then removed from the casing. 8a. The moulding material is then separated from around the ball and the hand cast. 9a. The replica hand holding the original baseball as an ornament.

The following documents include ten descriptions of the new innovation. Each using a different object but all applying the same new method of technique.

### The Hand and Object Casting Method and Kit

### Contents and Method of a ‘Baseball Holder’ Casting Kit

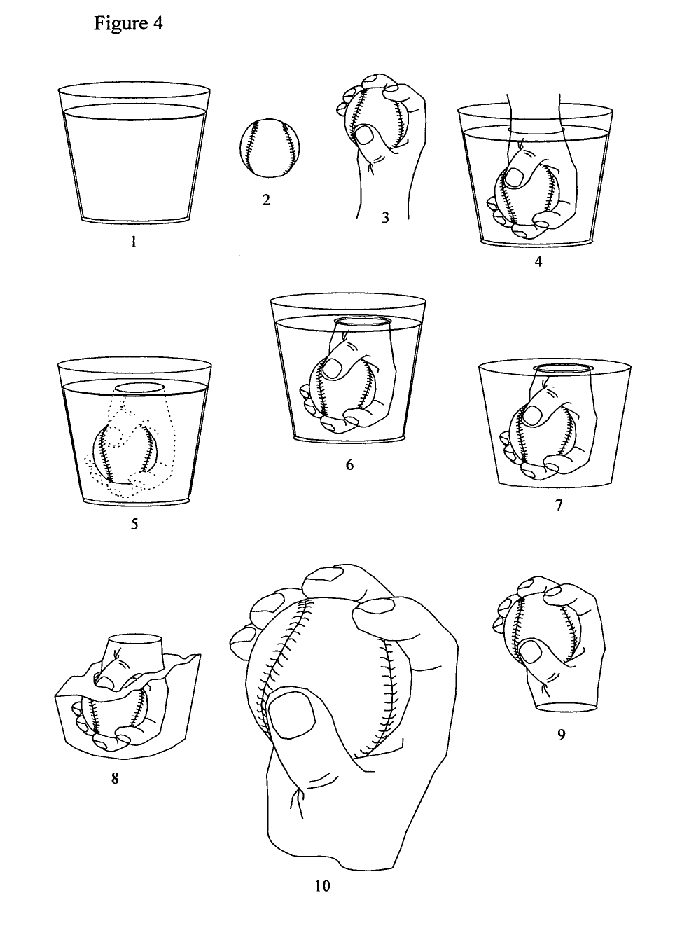

FIG. 3. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. a bag containing plastic gloves for use when mixing 3. & 5. or applying 6. 9. a stirring spatula for mixing 6. & 7 . . . 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. Standard size baseball.

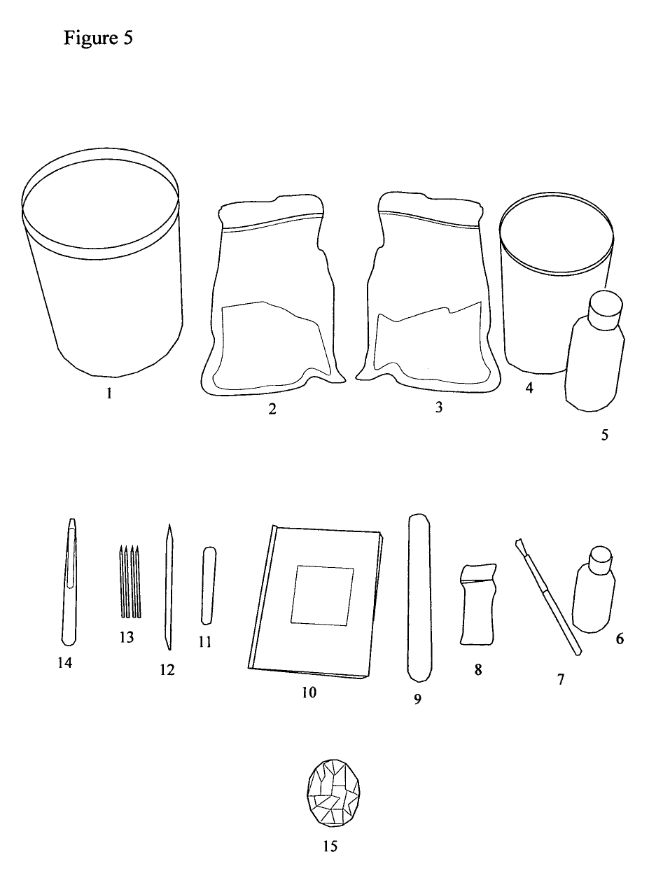

### FIG. 4. Side View

### Method.

Pour a small amount of the mixed impression taking material into a specified plastic mould casing 1. The model (a person having their hand replicated) holds an object 2. in their preferred hand and it is held as shown in 3. The hand and the object are immersed into the mixture in the mould casing 4. No part of the hand must touch the sides or base of the casing but the object can. During the setting period of the impression taking material the hand and object must be kept as motionless as possible to allow the replicated shape of the hand to form.

The impression taking material will set firm within a given time frame depending on the mix ratio. When the full curing time has been achieved, the hand can be carefully removed from the moulding material 5.

The object 2. remains encapsulated in the casing and immersed in the hardened moulding material 5. The void left by the removal of the hand is invested with a soluble self hardening substance.

The mixture is poured slowly and evenly into the void of the mould, whilst investing the mould, the casing is gently agitated by tapping the outside of the plastic case with a wooden spoon or similar utensil. The agitation and vibration will help the self hardening mixture to flow freely around the void and the encased object 2. and will also disperse any air bubbles that may be trapped. The soluble self hardening substance is allowed to cure and set hard to form the shape within the mould that the hand created during the mould making procedure 6.

When the substance is fully cured and set, the firm moulding material with the object 2. contained inside and held in place by the solid hand cast replica can now be removed from the plastic casing 7. With the set moulding material exposed it can be peeled away from the replica hand cast and the object 8.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9. The replica hand cast holding the original object is a personalised unique sculptured ornament and a record of the models hand holding a desired object 10.

### The Hand and Object Casting Method and Kit

### Contents and Method for a ‘Birth-Stone Holder’ Casting Kit

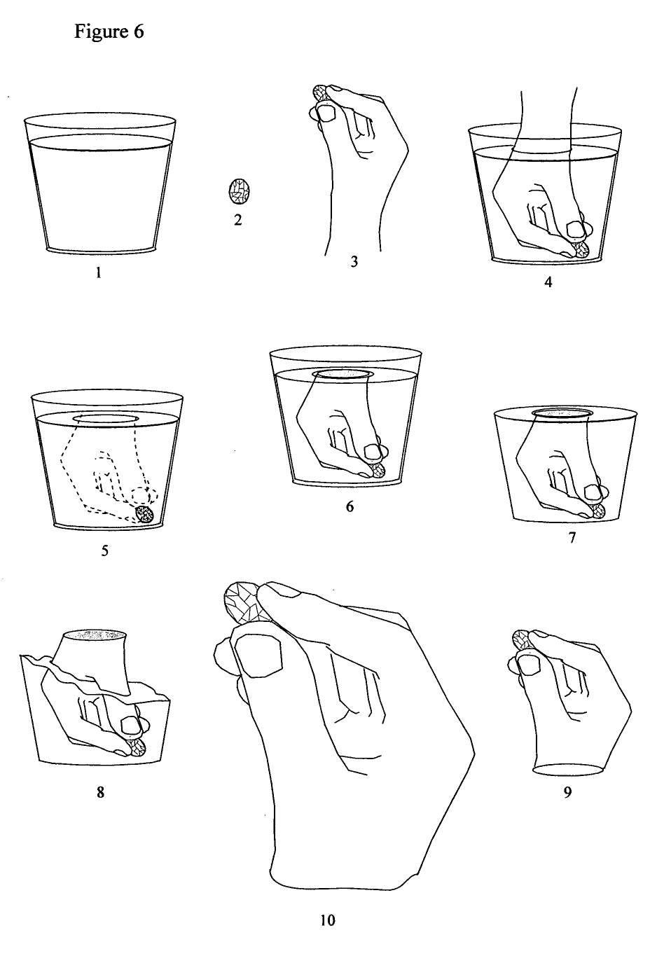

FIG. 5. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 3. & 5. or applying 6 . . . 9. a stirring spatula for mixing 3. & 5 . . . 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. A metal file and detailing tool for picking off excrescences and for smoothing rough areas of the cast. 15. A Birth-stone. (semi precious mineral tumble stones relating to birth signs).

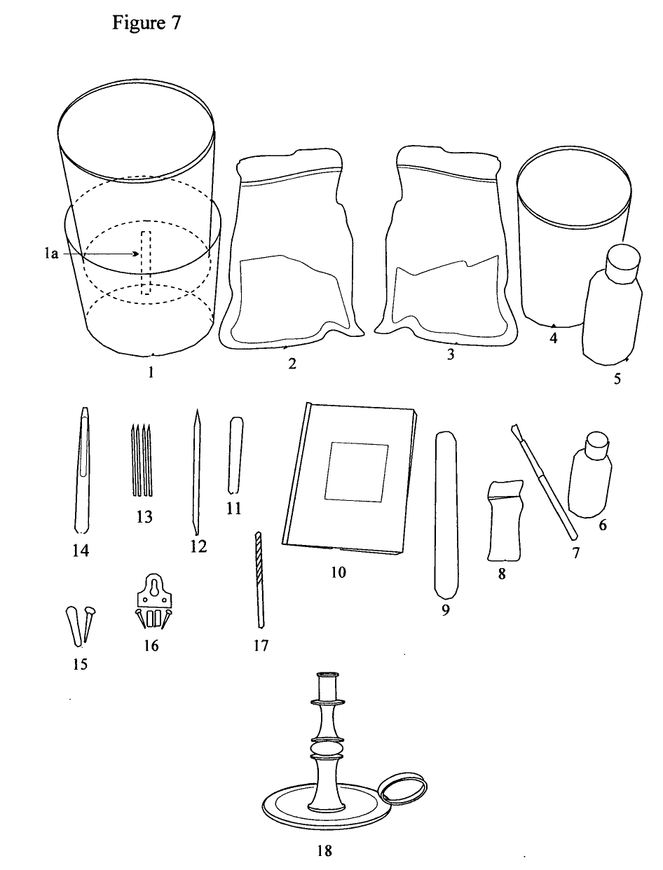

### FIG. 6. Side View

### Method.

Pour a small amount of the mixed impression taking material into a specified plastic mould casing l.The model (a person having their hand replicated) holds an object 2. in their preferred hand and it is held as shown in 3. The hand and the object are immersed into the mixture in the mould casing 4. no part of the hand must touch the sides or base of the casing but the object can. During the setting period of the impression taking material the hand and object must be kept as motionless as possible to allow the replicated shape of the hand to form.

The impression taking material will set firm within a given time frame depending on the mix ratio. When the full curing time has been achieved, the hand can be carefully removed from the moulding material 5. The object 2. remains encapsulated in the casing and immersed in the hardened moulding material 5. The void now left by the removal of the hand is invested with a soluble self hardening substance.

The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2. and will also disperse any air bubbles that may be trapped. The soluble self hardening substance is allowed to cure and set hard to form the shape within the mould that the hand created during the mould making procedure 6.

When the substance is fully cured and set, the firm moulding material with the object 2. contained inside and held in place by the solid hand cast replica can now be removed from the plastic casing 7. With the set moulding material exposed it can be peeled away from the replica hand cast and the object &

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9. The replica hand cast holding the original object is a personalised unique sculptured ornament and a record of the models hand holding a desired object 10.

### The Hand and Object Casting Method and Kit.

### Contents and Method of a ‘Candlestick Holder’ Casting Kit.

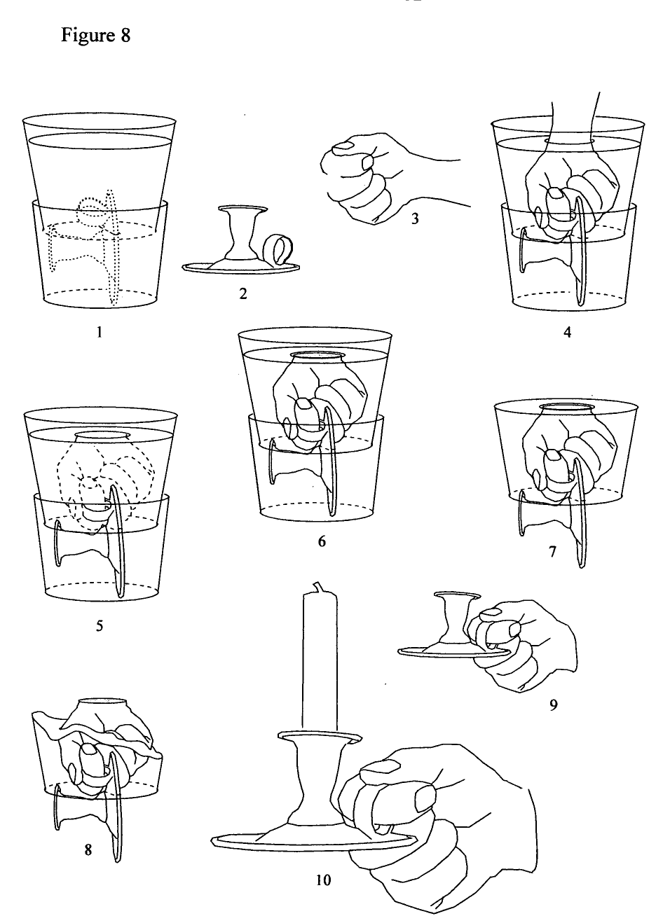

FIG. 7. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 3. & 5. or applying 6. 9. a stirring spatula for mixing 3. & 5. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. Wall screw and plug. 16. Wall mounting plate and fixings. 17. Drill-bit for plug apertures in mounting plate. 18. Chamber-stick.

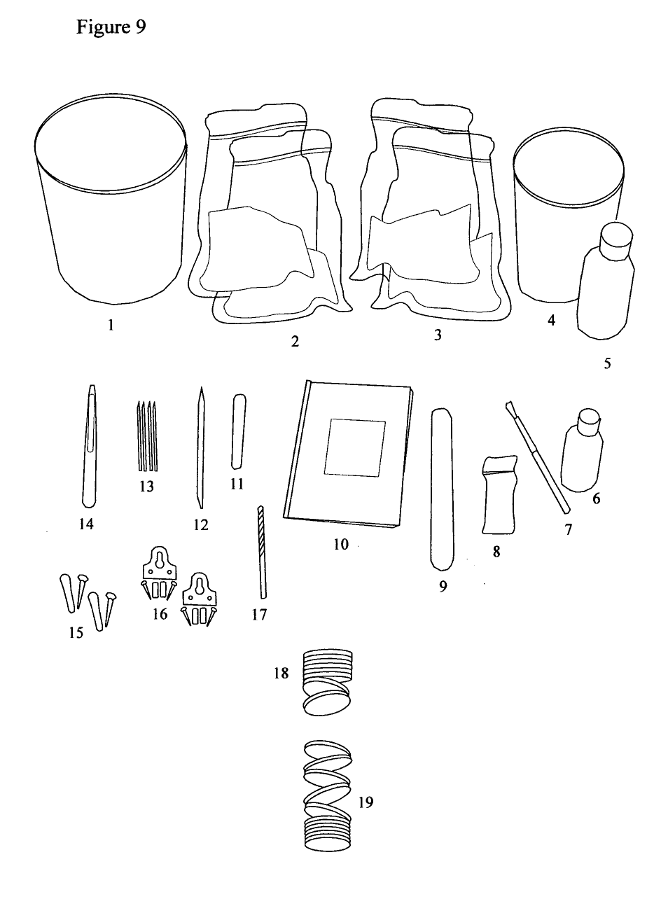

### FIG. 8. Side View

### Method

The object is pre-fitted within the mould casing 1. The model (a person having their hand replicated) uses their preferred hand to hold the object as shown 4. With the hand firmly gripping the object, pour a small amount of mixed impression taking material over it and the hand. No part of the hand must touch the sides or base of the casing but the object can. During the setting period of the impression taking material the hand and object must be kept as motionless as possible to allow the replicated shape of the hand to form. The impression taking material will set firm within a given time frame depending on the mix ratio.

When the full curing time has been achieved, the hand can be carefully removed from the moulding material 5. The object 2. remains encapsulated in the casing and immersed in the hardened moulding material 5. The void now left by the removal of the hand is invested with a soluble self hardening substance.

The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2. and will also disperse any air bubbles that may be trapped. The soluble self hardening substance is allowed to cure and set hard to form the shape within the mould that the hand created during the mould making procedure 6.

When the substance is fully cured and set, the firm moulding material with the object 2. contained inside and held in place by the solid hand cast replica can now be removed from the plastic casing 7. With the set moulding material exposed it can be peeled away from the replica hand cast and the object 8.

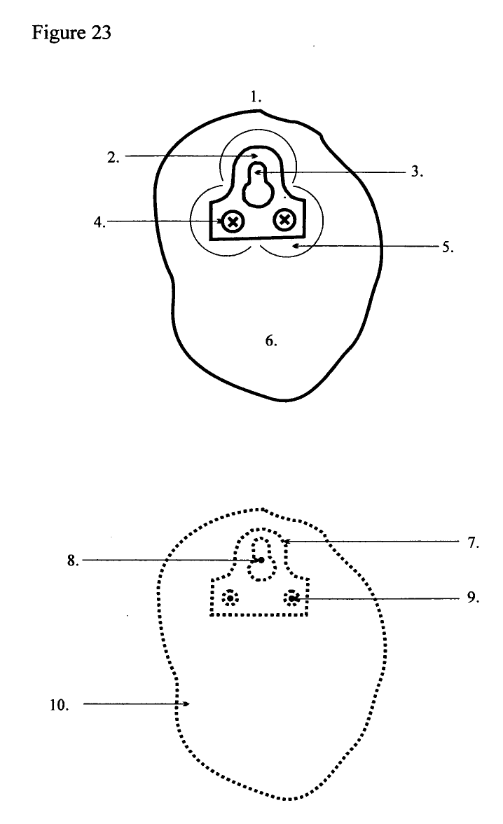

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9. The replica hand cast holding the original object is a personalised unique sculptured ornament and a record of the models hand holding a desired object 10. For wall mounting instructions see FIG. 23.

### FIG. 23. Rear View

1. Rear (base) of the completed hand and object cast ready for wall mounting. The wall plate 2. (FIG. 7. 16.) should be fixed at the top centre of the rear of the cast (do notfit the plate too near the edges of the cast). A small depression 3. needs to be made to accommodate the wall screw. (FIG. 7. 15.). The two screws 4. are to fix the plate to the back of the cast.

Draw around the shape of the plate 7. when you are confident that it is in the correct position. Make a shallow rebate to the shape of the plate in the base of the cast to accommodate the plate and screw heads 5. Drill two pilot holes 5 mm×15 mm deep to fit the plugs 9. also drill one pilot hole 5 mm×8 mm deep 8. and ream out to form the depression to accommodate the wall screw 3. (FIG. 7. 15).

Use the drill bit supplied (FIG. 7. 17.). When all the sculpture's fixings are complete, fix the wall screw (FIG. 7. 15) at your desired location. Place the casting flat on a piece of white paper and draw around the base 10. holding the paper against the base rub your fingers over the wall plate and it's screws to create a template to help position your piece/pieces on the wall.

### The Hand and Object Casting Method and Kit

### Contents and Method for a ‘Poker Chips Holder’

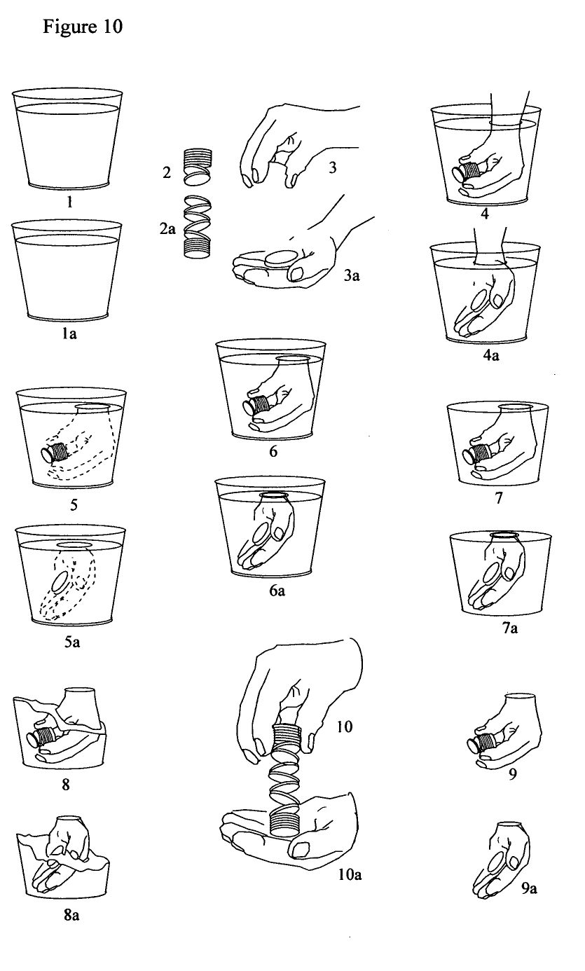

FIG. 9. View from Above

### Contents.

1. A plastic mould casing. 2. 2 foil bags containing a specific amount of impression taking material. 3. Two foil bags containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 3. & 5. or applying 6. 9. a stirring spatula for mixing 3.& 5. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. Two wall screws and plugs. 16. Two wall mounting plates and fixings. 17. Drill-bit for plug apertures in mounting plate. 18. Top fixed stack of poker chips. 19. Bottom fixed stack of poker chips.

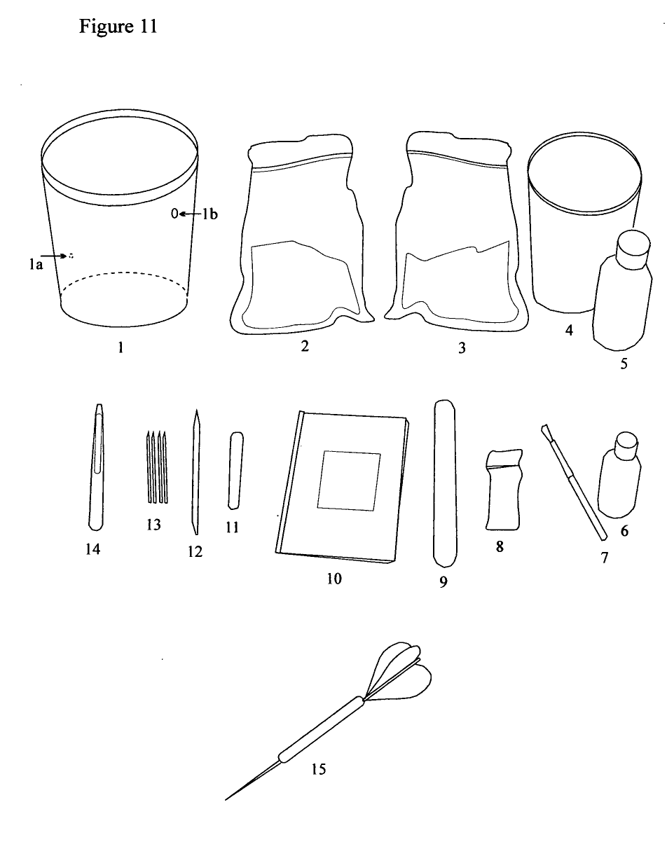

### FIG. 10. Side View

### Method

The Casting Method is the Same for Both Hands. Follow 1 to 10 for the Top Hand and Follow 1a to 10a for the Lower Hand

Pour a small amount of mixed impression taking material into the specified mould casing 1.-1a. The model (a person having their hand replicated) holds an object 2.-2a. in their preferred hand as shown by 3-3a. For casting the lower hand (a) use the single object in the palm as shown by 3a. the multiples are fitted when the cast is wall mounted. The hand and the object are immersed into the mixture and the casing 4-4a. No part of the hand must touch the sides or base of the casing but the object can.

During the setting period of the impression taking material the hand and object must be kept as motionless as possible to allow the replicated shape of the hand to form. The impression taking material will set firm within a given time frame depending on the mix ratio. When the full curing time has been achieved, the hand can be carefully removed from the moulding material 5.-5a. The object 2.-2a. remains encapsulated in the casing and immersed in the hardened moulding material 5.-5a.

The void now left by the removal of the hand is invested with a soluble self hardening substance. The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2.-2a. and will also disperse any air bubbles that may be trapped The soluble self hardening substance is allowed to cure and set hard to form the shape within the mould that the hand created during the mould making procedure 6.-6a.

When the substance is fully cured and set, the firm moulding material with the object 2.-2a. contained inside and held in place by the solid hand cast replica can now be removed from the plastic casing 7.-7a. With the set moulding material exposed it can be peeled away from the replica hand cast and the object 8.-8a.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9.-9a. The replica hand cast holding the original object is a personalised unique sculptured ornament and a record of the models hand holding a desired object 10.-10a. For wall mounting instructions see FIG. 23.

### The Hand Object Casting Method and Kit

### Contents and Method for a ‘Dart Holder’ Casting Kit.

FIG. 11. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 3. & 5. or applying 6. 9. a stirring spatula for mixing 3. & 5. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. A standard size dart.

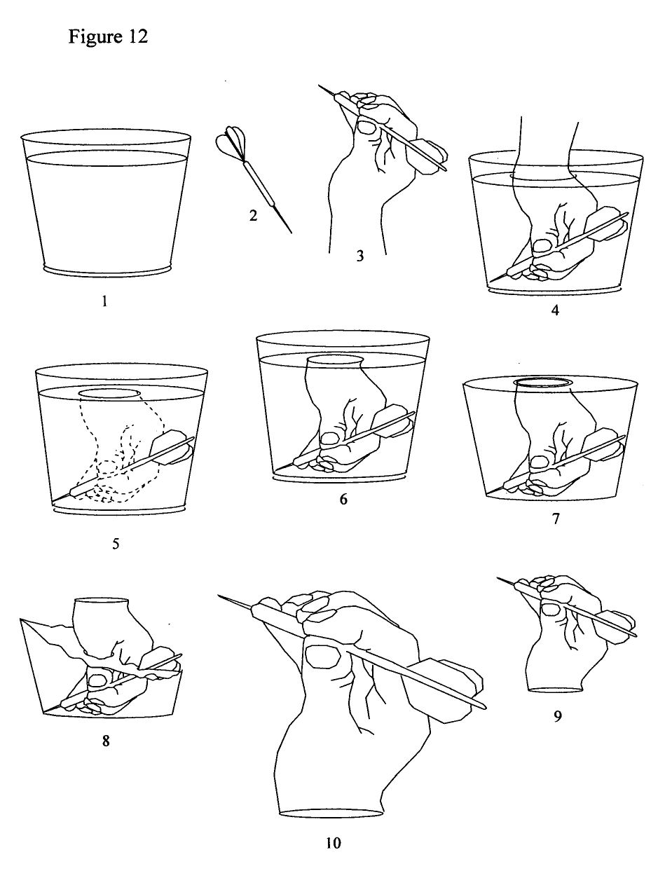

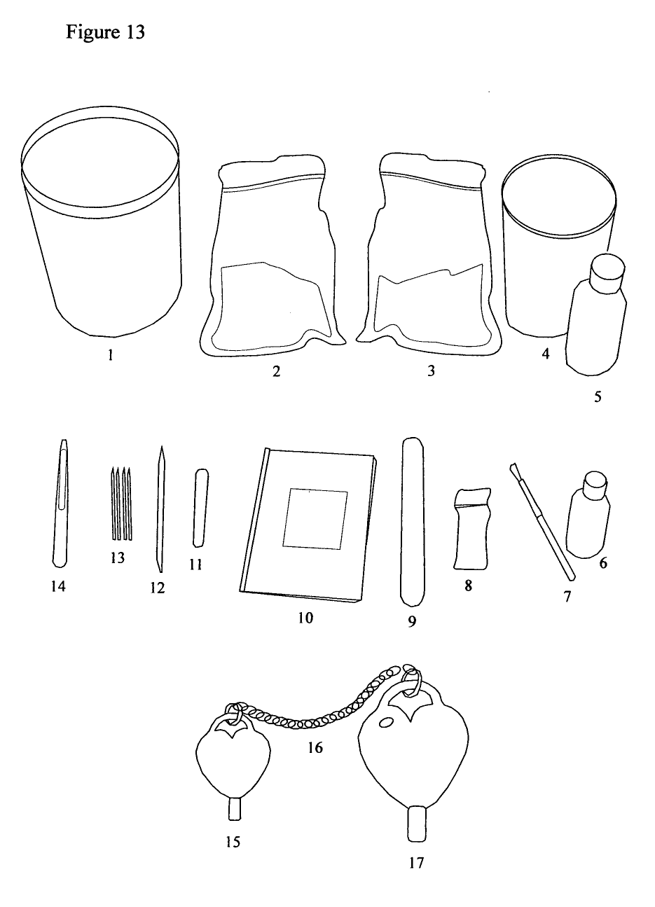

### FIG. 12. Side View

### Method.

Pour a small amount of the mixed impression taking material into a specified plastic mould casing l.The model (a person having their hand replicated) holds an object 2. in their preferred hand and it is held as shown in 3. The hand and the object are immersed into the mixture in the mould casing 4. No part of the hand must touch the sides or base of the casing but the object can. During the setting period of the impression taking material the hand and object must be kept as motionless as possible to allow the replicated shape of the hand to form. The impression taking material will set firm within a given time frame depending on the mix ratio.

When the full curing time has been achieved, the hand can be carefully removed from the moulding material 5. The object 2. remains encapsulated in the casing and immersed in the hardened moulding material 5. The void now left by the removal of the hand is invested with a soluble self hardening substance. The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2. and will also disperse any air bubbles that may be trapped

The soluble self hardening substance is allowed to cure and set hard to form the shape within the mould that the hand created during the mould making procedure 6. When the substance is fully cured and set, the firm moulding material with the object 2. contained inside and held in place by the solid hand cast replica can now be removed from the plastic casing 7. With the set moulding material exposed it can be peeled away from the replica hand cast and the object 8.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9. The replica hand cast holding the original object is a personalised unique sculptured ornament and a record of the models hand holding a desired object 10.

### A Hand and Object Casting Method Kit

### Contents and Method for a ‘Hearts and Chains Holder’ Casting Kit.

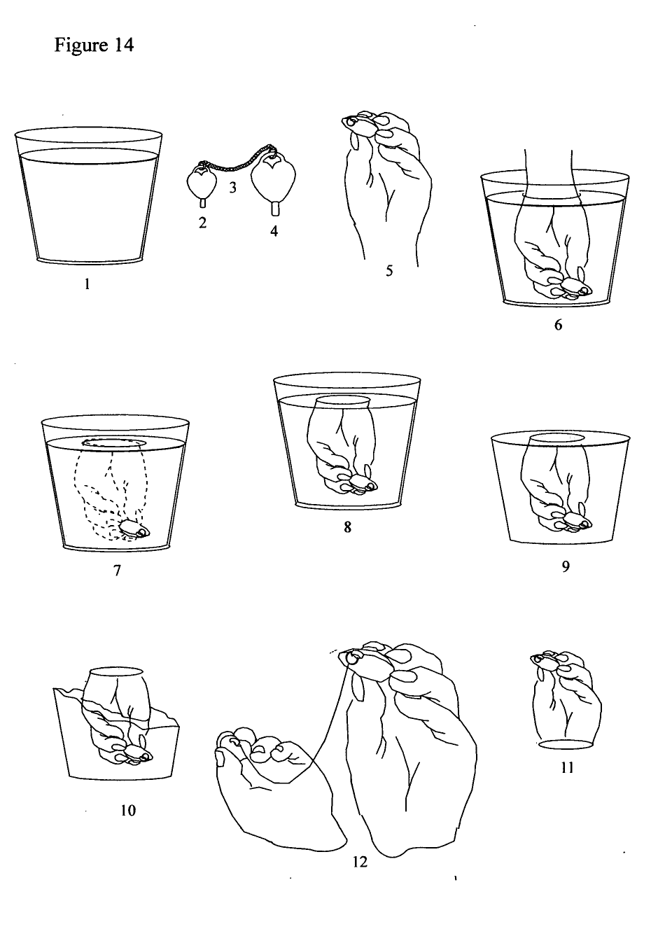

FIG. 13. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 6. & 7. 9. a stirring spatula for mixing 6. & 7. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. Small heart. 16. Chain 17. Large heart.

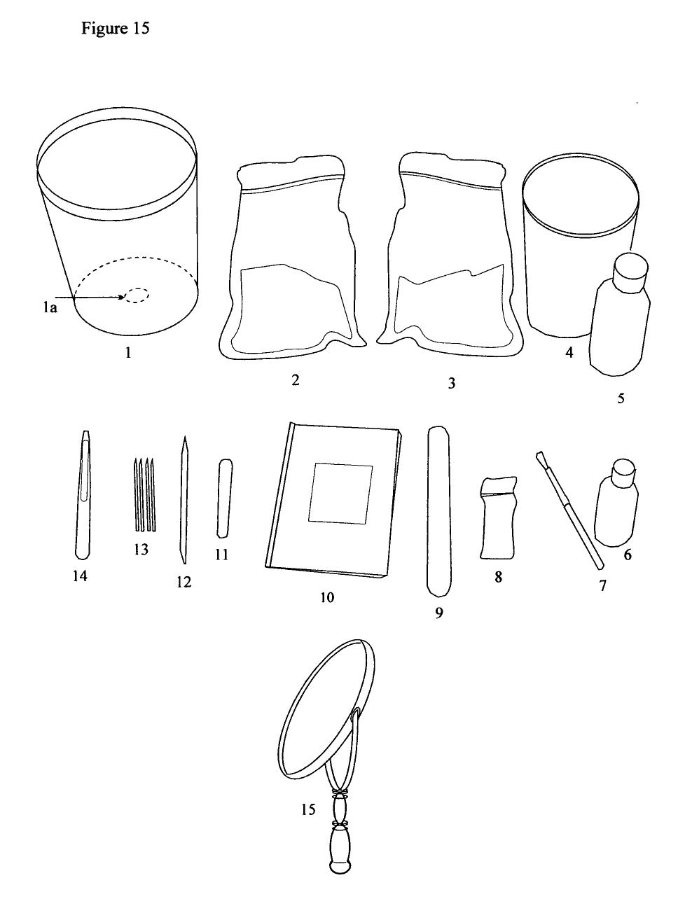

### FIG. 14. Front View

### Method.

Follow the Same Method for Small Heart as for the Large Heart. The Two Sculptures are Linked Together with the Chain when Complete.

Pour a small amount of the mixed impression taking material into a specified plastic mould casing 1. The model (a person having their hand replicated) holds an object 2.-4. in their preferred hand and it is held as shown in 5. The hand and the object are immersed into the mixture in the mould casing 6. No part of the hand must touch the sides or base of the casing but the object can.

During the setting period of the impression taking material the hand and object must be kept as motionless as possible to allow the replicated shape of the hand to form. The impression taking material will set firm within a given time frame depending on the mix ratio. When the full curing time has been achieved, the hand can be carefully removed from the moulding material 7. The object 2.-4. remains encapsulated in the casing and immersed in the hardened moulding material 8.

The void now left by the removal of the hand is invested with a soluble self hardening substance. The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2.-4. and will also disperse any air bubbles that may be trapped. The soluble self hardening substance is allowed to cure and set hard to form the shape within the mould that the hand created during the mould making procedure 6.

When the substance is fully cured and set, the firm moulding material with the object 2.-4. contained inside and held in place by the solid hand cast replica can now be removed from the plastic casing 9. With the set moulding material exposed it can be peeled away from the replica hand cast and the object 10.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 11. The replica hand cast holding the original object is a personalised unique sculptured ornament and a record of the models hand holding a desired object 12.

### The Hand and Object Casting Method and Kit

### Contents and Method for a ‘Mirror Holder’ Casting Kit.

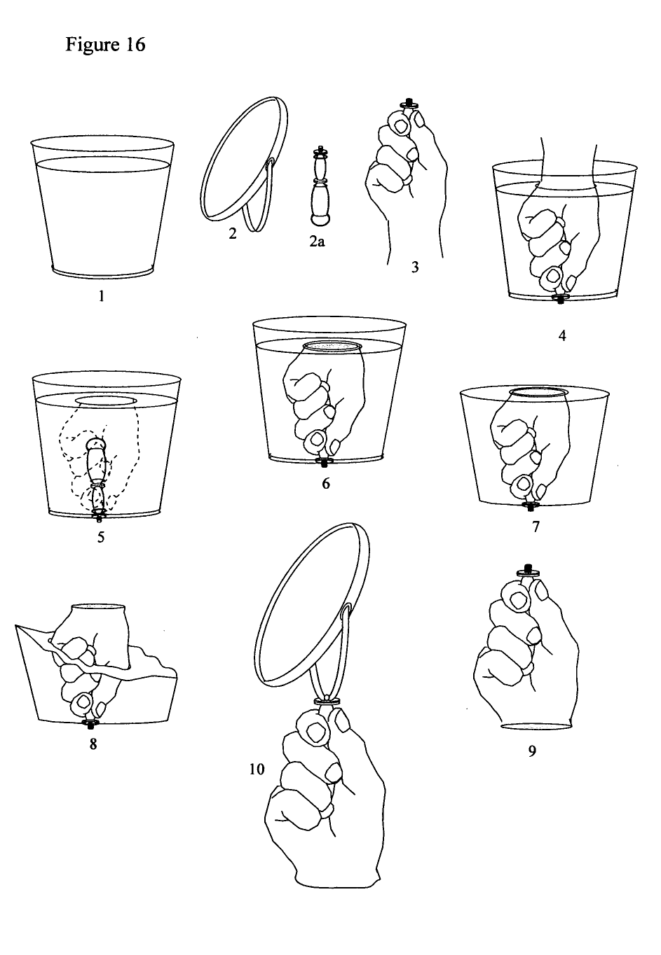

FIG. 15. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 6. & 7. 9. a stirring spatula for mixing 6. & 7. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. A standard tilting mirror.

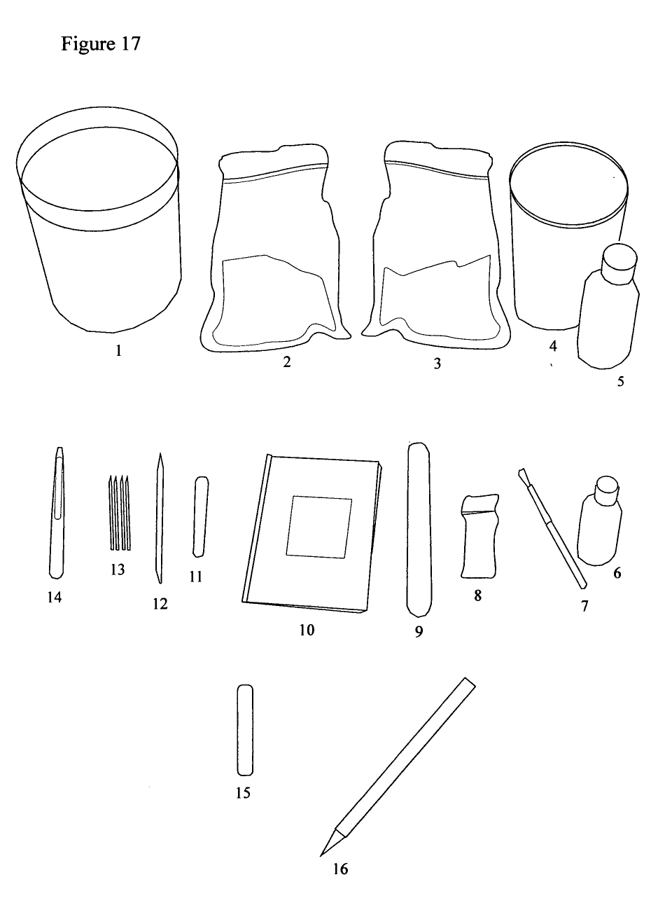

### FIG. 16. Side View

### Method.

Separate the Mirror from It's Handle and Use the Handle as the Object. Refit the Mirror when the Casting is Complete.

Pour a small amount of the mixed impression taking material into a specified plastic mould casing 1. The model (a person having their hand replicated) holds an object 2a. in their preferred hand and it is held as shown in 3. The hand and the object are immersed into the mixture in the mould casing 4. No part of the hand must touch the sides or base of the casing but the object can.

During the setting period of the impression taking material the hand and object must be kept as motionless as possible to allow the replicated shape of the hand to form. The impression taking material will set firm within a given time frame depending on the mix ratio. When the full curing time has been achieved, the hand can be carefully removed from the moulding material 5. The object 2a. remains encapsulated in the casing and immersed in the hardened moulding material 5.

The void now left by the removal of the hand is invested with a soluble self hardening substance. The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2a. and will also disperse any air bubbles that may be trapped. The soluble self hardening substance is allowed to cure and set hard to form the shape within the mould that the hand created during the mould making procedure 6.

When the substance is fully cured and set, the firm moulding material with the object 2a. contained inside and held in place by the solid hand cast replica can now be removed from the plastic casing 7. With the set moulding material exposed it can be peeled away from the replica hand cast and the object 8.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9. The replica hand cast holding the original object is a personalised unique sculptured ornament and a record of the models hand holding a desired object 10.

### The Hand and Object Casting Method and Kit

### Contents and Method for a ‘Pencil Holder’ Casting Kit.

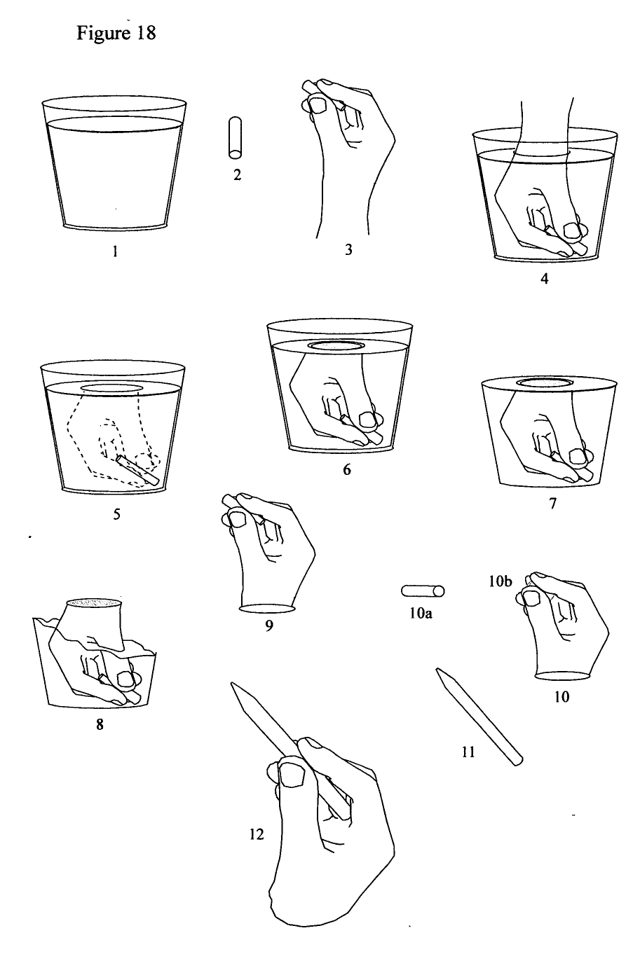

FIG. 17. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 6. & 7. 9. a stirring spatula for mixing 6. & 7. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. A section of silicon dowel. 16. A pencil

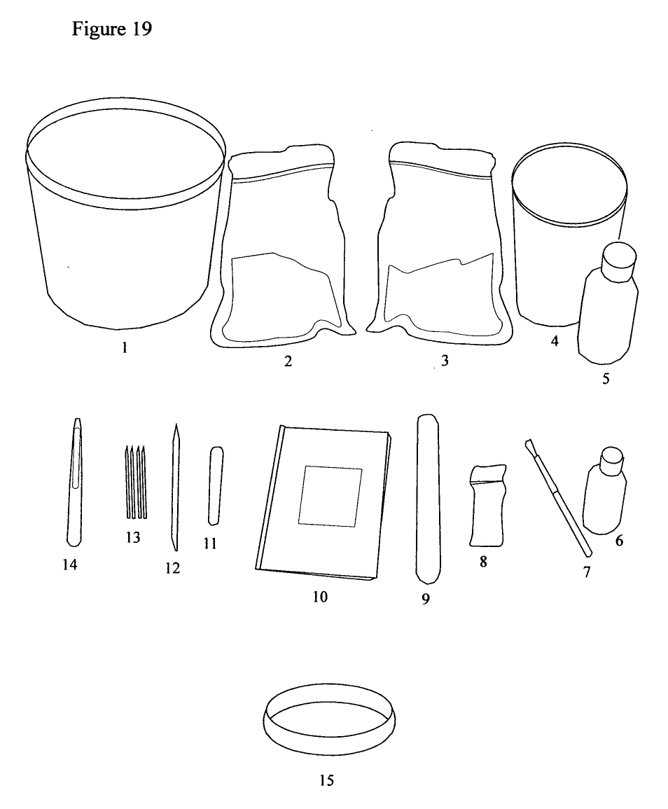

### FIG. 18. Side View

### Method.

Use the Silicon Dowel for the Casting Session, Remove and Replace with the Pencil when the Casting has Cured.

Pour a small amount of the mixed impression taking material into a specified plastic mould casing 1. The model (a person having their hand replicated) holds an object 2. in their preferred hand and it is held as shown in 3. The hand and the object are immersed into the mixture in the mould casing 4. No part of the hand must touch the sides or base of the casing but the object can. During the setting period of the impression taking material the hand and object must be kept as motionless as possible to allow the replicated shape of the hand to form. The impression taking material will set firm within a given time frame depending on the mix ratio.

When the full curing time has been achieved, the hand can be carefully removed from the moulding material 5. The object 2. remains encapsulated in the casing and immersed in the hardened moulding material 5. The void now left by the removal of the hand is invested with a soluble self hardening substance. The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2. and will also disperse any air bubbles that may be trapped.

The soluble self hardening substance is allowed to cure and set hard to form the shape within the mould that the hand created during the mould making procedure 6. When the substance is fully cured and set, the firm moulding material with the object 2. contained inside and held in place by the solid hand cast replica can now be removed from the plastic casing 7. With the set moulding material exposed it can be peeled away from the replica hand cast and the object 8.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9. The replica hand cast holding the original object is a personalised unique sculptured ornament and a record of the models hand holding a desired object 10.

### The Hand and Object Casting Method and Kit

### Contents and Method for a ‘Ring Holder’ Casting Kit.

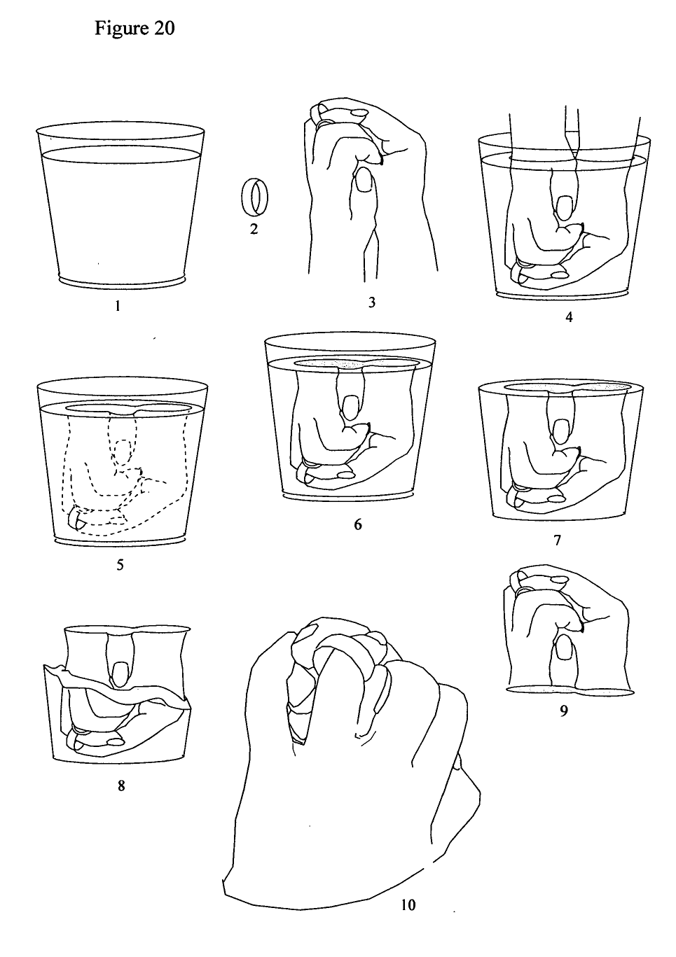

FIG. 19. View from Above

### Contents.

1. A plastic mould casing. 2. a foil bag containing a specific amount of impression taking material. 3. a foil bag containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 6. & 7. 9. a stirring spatula for mixing 6. & 7. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. A metallic ring.

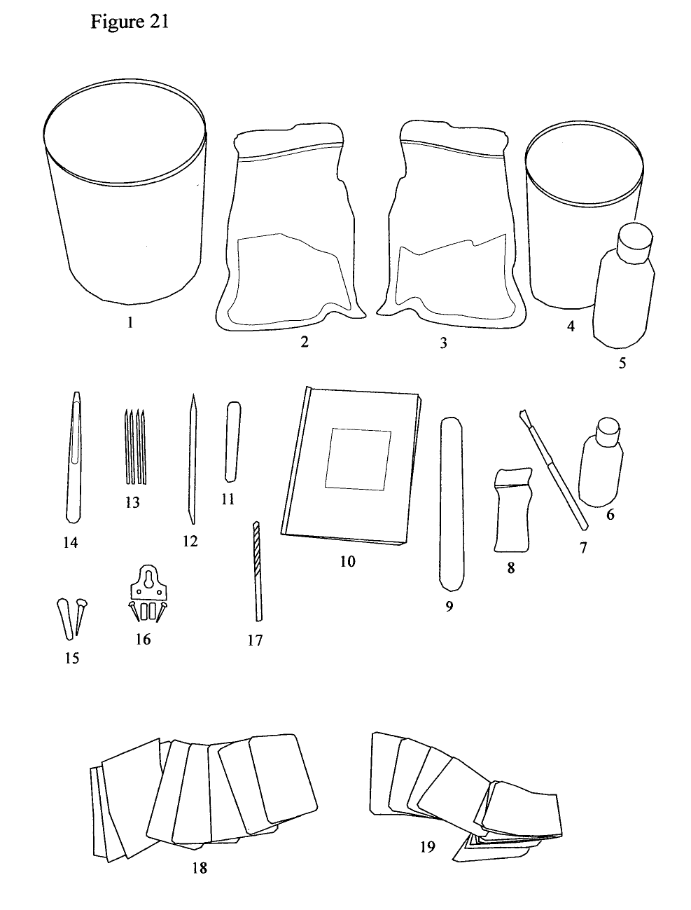

### FIG. 20. Side View at 3. Front View at 10

### Method.

### This is a Two Handed Cast, Completed in Tandem.

Pour a small amount of the mixed impression taking material into a specified plastic mould casing 1. The model (a person having their hand replicated) holds an object 2. in their preferred hand and it is held as shown in 3. The hand and the object are immersed into the mixture in the mould casing 4. No part of the hand must touch the sides or base of the casing but the object can. During the setting period of the impression taking material the hand and object must be kept as motionless as possible to allow the replicated shape of the hand to form. The impression taking material will set firm within a given time frame depending on the mix ratio.

When the full curing time has been achieved, the hand can be carefully removed from the moulding material 5. The object 2. remains encapsulated in the casing and immersed in the hardened moulding material 5. The void now left by the removal of the hand is invested with a soluble self hardening substance.

The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2. and will also disperse any air bubbles that may be trapped. The soluble self hardening substance is allowed to cure and set hard to form the shape within the mould that the hand created during the mould making procedure 6.

When the substance is fully cured and set, the firm moulding material with the object 2. contained inside and held in place by the solid hand cast replica can now be removed from the plastic casing 7. With the set moulding material exposed it can be peeled away from the replica hand cast and the object 8.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9. The replica hand cast holding the original object is a personalised unique sculptured ornament and a record of the models hand holding a desired object 10.

### The Hand and Object Casting Method and Kit

### Contents and Method for a ‘Playing Cards Holder’. Casting Kit

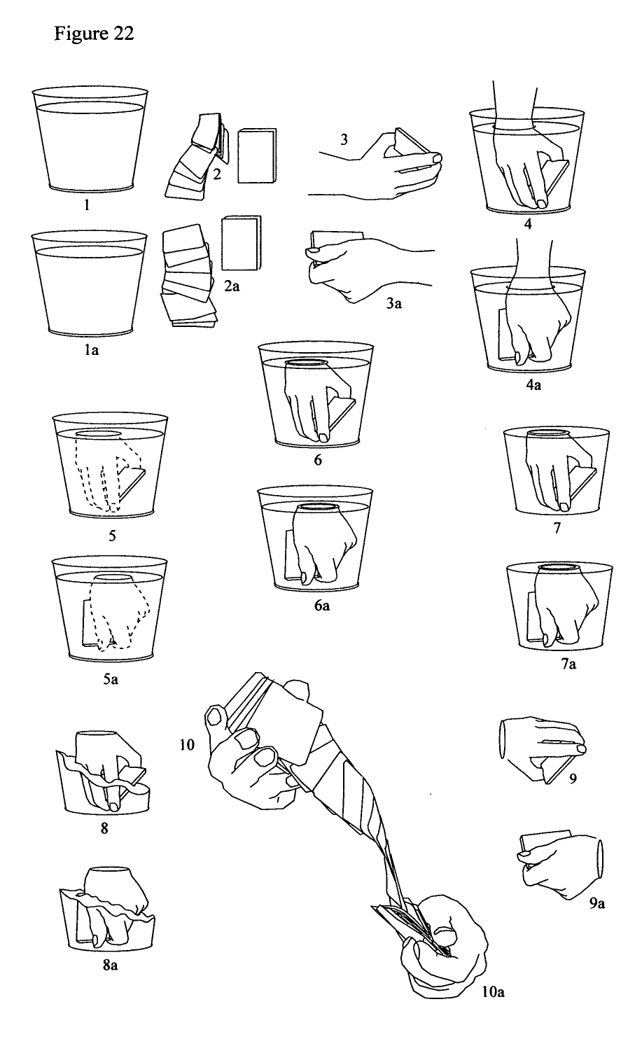

FIG. 21. View from Above

### Contents.

1. A plastic mould casing. 2. Two foil bags containing a specific amount of impression taking material. 3. Two foil bags containing a specific amount of a soluble self hardening substance. 4. a plastic mixing pot. 5. a bottle of liquid formula for mixing the self hardening substance. 6. a small bottle of preserving lacquer. 7. a small lacquer applying brush. 8. A bag containing plastic gloves for use when mixing 6.&7. 9. a stirring spatula for mixing 6.& 7. 10. the instruction booklet. 11. a small emery board for smoothing rough areas of the finished cast. 12. a large wooden picking tool for carefully gouging out the moulding material. 13. four small wooden picking tools for carefully prizing the moulding material from small crevices and folds. 14. a metal file and detailing tool for picking off excrescences and for smoothing rough areas of the cast. 15. Two wall screws and plugs. 16. Two wall mounting plates and fixings. 17. Drill-bit for plug apertures in mounting plate. 18. A substitute spacer and top set of playing cards. 19. A substitute spacer and lower set of playing cards.

FIG. 22. Side View at 3 and 3a. Front View at 10 and 10a

### Method

The Casting Method is the Same for Both Hands. Follow 1 to 10 for the Top Hand and Follow 1a to 10a for the Lower Hand.

Pour a small amount of mixed impression taking material into the specified mould casing 1.-1a. The model (a person having their hand replicated) holds an object 2.-2a. in their preferred hand as shown by 3.-3a. For casting the lower hand a use a single object in the palm as shown by 3a. the multiples are fitted when being wall mounted. The hand and the object are immersed into the mixture and the casing 4.-4a. No part of the hand must touch the sides or base of the casing but the object can. During the setting period of the impression taking material the hand and object must be kept as motionless as possible to allow the replicated shape of the hand to form. The impression taking material will set firm within a given time frame depending on the mix ratio.

When the full curing time has been achieved, the hand can be carefully removed from the moulding material 5.-5a. The object 2.-2a. remains encapsulated in the casing and immersed in the hardened moulding material 5.-5a The void now left by the removal of the hand is invested with a soluble self hardening substance. The mixture is poured slowly and evenly into the void of the mould. Whilst investing the mould, the casing is gently agitated by tapping the outside of the plastic case with a wooden spoon or similar utensil. The agitation and vibration will help the self hardening mixture to flow freely around the void and the encased object 2.-2a. and will also disperse any air bubbles that may be trapped

The soluble self hardening substance is allowed to cure and set hard to form the shape within the mould that the hand created during the mould making procedure 6.-6a. When the substance is fully cured and set, the firm moulding material with the object 2.-2a. contained inside and held in place by the solid hand cast replica can now be removed from the plastic casing 7.-7a. With the set moulding material exposed it can be peeled away from the replica hand cast and the object 8.-8a.

Using the designated tools all of the moulding material is cleaned from the hardened cast. The replica hand can have any excrescences removed and smoothed with the appropriate tools. The dressed replica hand cast is then coated with a preservative treatment and self-adhesive baize material attached to the base 9.-9a. The replica hand cast holding the original object is a personalised unique sculptured ornament and a record of the models hand holding a desired object 10.-10a. For wall mounting instructions see FIG. 3

The claims defining the invention as follows:

1. The human hand is normally replicated using an established casting procedure. The innovation to that established procedure and it's product is that the hand can be replicated holding a variety of objects, whereby the object remains in the mould during the casting process and after the hand has been removed. A hard setting substance is invested into the mould filling the void left by the hand. The substance then forms the exact shape around the object that the hand did prior to it's removal. The product is an exact replica of the human hand holding the original object.

2. The object/objects and object parts referred to in the above claim are by the nature of their use and size, capable of being held in the human hand.

3. The objects shown in this application are for illustration purposes only, to show the versatility and diversity of the innovation to the process. The term object refers to any object or object part that is capable of being held in the human hand and thereby conjoined with and together capable of being immersed in an impression taking material.
